(19) United States
(12) Patent Application Publication
(10) Pub. No.: US 2007/0246940 A1
(43) Pub. Date: Oct. 25, 2007

(54) Highway's electrogenerators

(76) Inventor: Jose Carlos Fajardo Valon, Miami, FL (US)

Correspondence Address: Jose C. Fajardo, 7240 SW 12th Street, Miami, FL, 33144, US

(21) Appl. No.: 11/416,480

(22) Filed: Apr. 24, 2006

(51) Int. Cl. H02K 7/18; F03G 7/08; F02B 63/04

(52) U.S. Cl. 290/1 R

(57) ABSTRACT

This method of generating electricity can bring us enormous savings in fuel. It can also be utilized to supply the electric energy necessary for the electrical systems of the highways, such as communication and the energy stations used to charge automobile batteries. Once we construct the prototype, we can measure the true benefits.

### OBJECTIVES:

1. Achieve the movement of an electro generator utilizing the movement of motor vehicles as initial energy.

2. Lay down the foundation for the construction of a generator plant through which the movement of the motor vehicles can be achieved.

3. Create a new method to produce electric energy.

### BACKGROUND

After analyzing all of the existing forms to generate electricity (thermo electric, hydroelectric, geologic, etc) the principal factor has been “the initial energy” and with the constant flow of automobiles on U.S. highways, we can use this energy produced by them. The movement of the motor vehicles as the “initial energy” necessary to put into movement a pumping system that will help at the same time to put into effect an electric generator.

### SUMMARY OF INVENTION

To put into movement the electric generator, we will utilize a pumping station and an impact platform. This impact platform will be installed into the road pavement crosswise or diagonally where there is flow of motor vehicles.

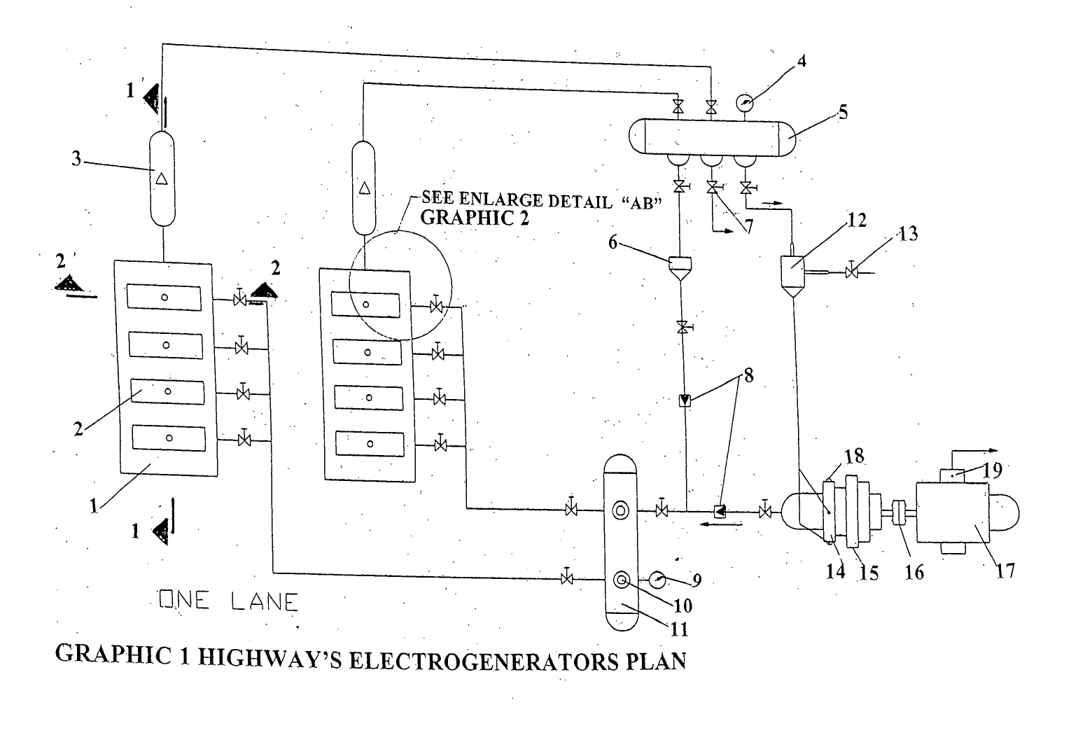

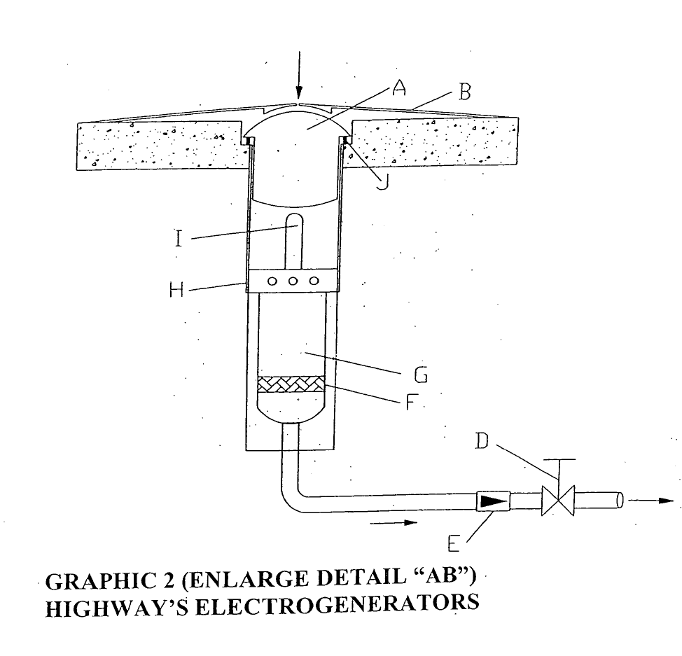

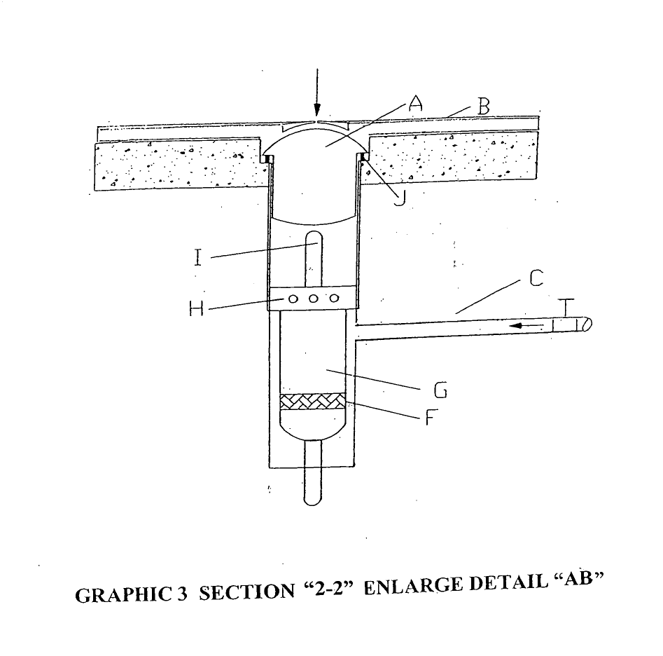

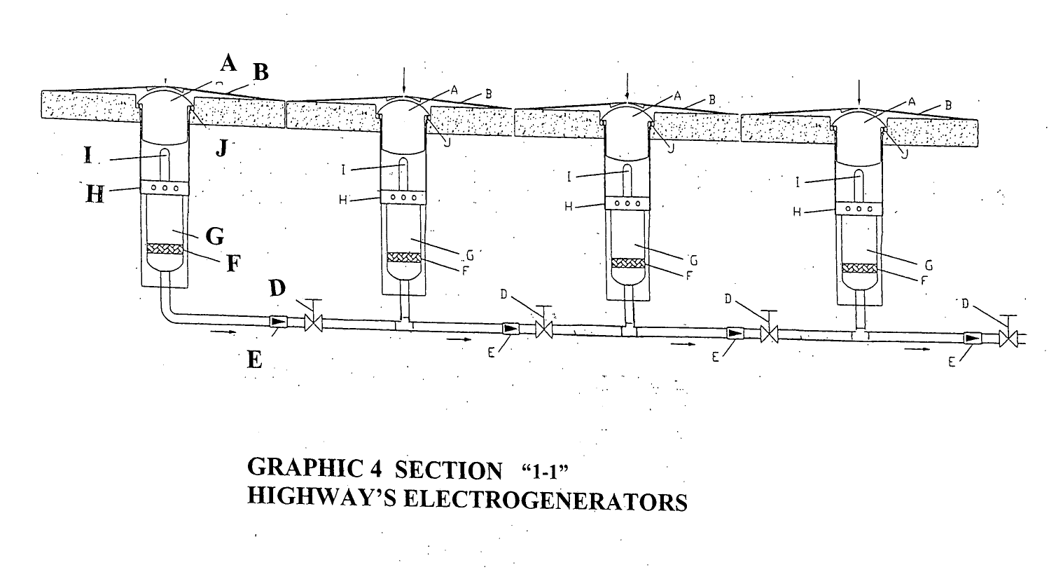

The pumping station will be filled with a special oil type fluid with medium viscosity. There will also be special pumps which will be installed underneath the impact platform (1) FIG. 1. The pumps will receive the impact by way of mechanical hammers (A) FIG. 2 installed above the piston of the pump with a spiral spring which allows it to return to it's descending position. The system will have check valve (3) (8) FIG. 1 installed to control the flow of fluid in one direction. This fluid will accumulate in a collection tank (5) FIG. 1. As it accumulates, the pressure in this tank (5) will inject in a tangent flow of oil into a hydraulic head (14) FIG. 1. This flow of oil will put into movement the rotor with vanes (18) FIG. 1. The rotor in this turbine will connect with the generator axle (17) FIG. 1 by way of accelerated transmission (15) FIG. 1. To achieve the necessary pressure we will utilize a pressure valve (12) FIG. 1 which will open the flow of oil after achieving the necessary pressure. Also, you can utilize in this initial moment a “Jump” auxiliary system to move the turbine (14) FIG. 1 in the event this would be necessary. Once the flow of oil passes through the turbine (14) it comes out through a line with a check valve connected to a collection tank (11) FIG. 1 and the return comes about by way of gravity and passes the oily solution to the pump (1) FIG. This is how the process is completed and is repeated constantly. As we know, oil can not be compressed but we can increase the pressure at different levels until we achieve our objective and the necessary pressure. In the impact platform FIGS. 2 & 3 there is Ramp A, hammers (A), springs (J), pumps (G), pistons (I), check valves (E), pump filter (F), supports for pump (H).

These pump stations and generator plants shall be installed pre-fabricated. This will reduce costs to a minimum which are necessary in the pavement of highways and proportion the capacity of the plant.

In FIG. 1 we have a relief valve (6) as a bypass if the pressure should rise to a higher level than necessary and for the good functioning of the system. The valve (7) Graphic 1 is for connection other hydraulic heads Graphic 1. In addition, there are manometers of pressure (4) (9) FIG. 1. The tank accumulates the return oil (11) which has in its superior part two openings with their respective covers (10).

The method of generating electricity utilizing the movement of the automobiles on the roads consists of making a closed system of circulation of oil. To achieve this we use an impact platform on a ramp and hammers which are then flatten by the weight of the automobiles. This is turn hits the piston of the special pumps and impulses the oil through the system until the necessary pressure is obtained in order to inject the oil to the turbines and start the movement which will then start the electric generator. The generated capacity is in proportion to the size of the plants. These electrical generator plants shall be installed on the side of the roads where there is a high volume of motor vehicles with few miles in between each.

1. 1—SHOCK RAMP, SEE GRAPHIC 1 “#1” AND GRAPHIC 2 LETTER “B”, RECEIVE THE IMPACT OF THE WEIGHT OF THE MOTOR VEHICLES TO ACTIVATE THE PUMPS
2—HAMMER SEE GRAPHIC 1 “#2” AND GRAPHIC 2 LETTER “A” TRANSMIT THE IMPACT TO THE PUMPS.
3—RECEIVING TANK COLLECT THE OILY SOLUTION SEE GRAPHIC 1 “#5”
4—TURBINE RECEIVE THE PRESSURE OF THE OILY SOLUTION TO MOVE THE GENERATOR SEE GRAPHIC 1 “#14”
5—TRANSMISSION SEE GRAPHIC 1 “#15 ”, COUPLING SEE GRAPHIC 1 “#16”
6—BYPASS AND SAFETY VALVE, RELEASE THE EXCESSIVE PRESSURE OF THE RECEIVING TANK SEE GRAPHIC 1 “#6”
